(19) United States
(12) Patent Application Publication
(10) Pub. No.: US 2022/0083655 A1
(43) Pub. Date: Mar. 17, 2022

(54) CHIP SECURITY ANALYSIS METHOD BASED ON PETRI NET

(71) Applicant: Beihang University, Beijing (CN)

(72) Inventors: Daming Yang, Beijing (CN); Zili Wang, Beijing (CN); Jiaoying Huang, Beijing (CN); Cheng Gao, Beijing (CN); Chengcheng Fu, Beijing (CN)

(73) Assignee: Beihang University, Beijing (CN)

(21) Appl. No.: 17/340,785

(22) Filed: Jun. 7, 2021

(30) Foreign Application Priority Data
Sep. 14, 2020 (CN) 202010961682.8

(51) Int. Cl. G06F 21/55

(52) U.S. Cl. CPC G06F 21/554; G06F 2221/034

(57) ABSTRACT

A chip security analysis method based on Petri net has five steps: 1, analyzing the behavior of a chip, the description file and its hierarchy; 2, establishing a Petri net model of a bottom unit; 3, integrating the Petri net model of the bottom unit into the Petri net model of an intermediate unit; 4, establishing the Petri net model of a top unit; 5, carrying out credibility analysis and hardware Trojan attack diagnosis based on the Petri net model. According to the present disclosure, the security hazards of hardware Trojan to chips are analyzed, and a chip security analysis method is proposed, which is a new method for quantitatively analyzing chip security based on the Petri net model, thus providing a new approach for security measurement and protection of integrated circuits.

### TECHNICAL FIELD

The present disclosure relates to a chip security analysis method, in particular to a chip security analysis method based on Petri net, and belongs to the field of integrated circuit security.

### BACKGROUND

With the rapid development and globalization of semiconductor field, EDA tools and IP core technology are developing rapidly, and the division of labor between semiconductor design and manufacturing process is further refined. It also brings more and more serious integrated circuit hardware security problems. Integrated circuit chips are widely used in national defense, finance, transportation, energy and other fields. Once attacked maliciously, it will bring incalculable losses. The importance of chip security has been paid more and more attention, especially in the field of hardware Trojan. Hardware Trojan refers to special circuit modules that are deliberately implanted or changed in the process of chip design or manufacturing. The verification and testing tools in a traditional form cannot detect this kind of security threat well, and this kind of security threat cannot be guaranteed to be completely eliminated in the design process. At present, there are more and more researches on hardware Trojan technology in the world, mainly focusing on detection and defense. After detecting hardware Trojan, it is necessary to further diagnose the location of the hardware Trojan and the type of the implanted hardware Trojan, determine the risky module and guide the security design against the hardware Trojan.

As a system modeling tool, the Petri net model has good system description characteristics and mathematical analysis ability. Moreover, the Petri net model has complete operation mechanism and rule mapping relationship, which intuitively reflects the change of the system state and the process of event development. The Petri net model is especially suitable for expressing the propagation process of failures. It is easy to infer the specific causes of failures by backward reasoning, so as to realize failure diagnosis. Therefore, it is widely used in system reliability and risk evaluation.

In the past decades, researchers have done a lot of researches on traditional Petri net, which greatly expand the theory of Petri net. Most influentially, color, time and hierarchy are expanded. Through these researches, the theory of High Level Petri Nets (HLPN) is gradually formed. HLPN can comprehensively consider factors such as data and time constraints in the system, which facilitates the modeling of complex systems. With the increase of complexity of description and the actual system state, researchers also put forward the theories of predicate transition network, fuzzy Petri net and stochastic Petri net. These advanced Petri net systems improve the abstractness of the system, broaden the application field of Petri net, and have been successfully applied in many research fields, such as performance evaluation, a communication protocol, a flexible manufacturing system, a failure diagnosis system, a management information system, an artificial intelligence system and so on.

According to the present disclosure, the security hazards of hardware Trojan to chips are mainly analyzed, and a chip security analysis method is proposed. It is a new method for quantitatively analyzing chip security based on the Petri net model, thus providing a new approach for security measurement and protection of integrated circuits.

### SUMMARY

### 1. Purpose

The purpose of the present disclosure is to provide a chip security analysis method based on Petri net, which can quantitatively analyze chip security and its bottom unit, thus providing a new approach for security measurement and protection of integrated circuits.

### 2. Technical Scheme

The present disclosure provides a chip security analysis method based on Petri net, comprising the steps of:

Step 1: analyzing the behavior of a chip, the description file and its hierarchy, and according to the behavior of the chip and the composition of the description file, decomposing the chip into three levels, wherein the first level is a top unit; the second level comprises several intermediate units after the top unit is decomposed; and the third level comprises several bottom units after each intermediate unit is decomposed;

Step 2: establishing a Petri net model of a bottom unit, wherein there are two places and one transition in this model, according to the fact that the bottom unit attacked by hardware Trojan obeys the exponential distribution, the transition rate of the model is obtained, and tokens with different shapes are added to the place to mark the type of hardware Trojan of the bottom unit that may be attacked;

Step 3: integrating the Petri net model of the bottom unit into the Petri net model of an intermediate unit, then converting the intermediate unit model into an equivalent single network model, and obtaining the equivalent conversion rate of each single network model according to the composition of the intermediate unit and the failure distribution parameters of the bottom unit;

Step 4: establishing the Petri net model of a top unit, analyzing the composition and the dynamic characteristics of the top unit, such as common cause failure, and obtaining the top unit model by integrating the single network model of the intermediate unit obtained in step 3;

Step 5: carrying out credibility analysis and hardware Trojan attack diagnosis based on the Petri net model, evaluating the credibility of the top unit and the intermediate unit by calculating the transition rate of each place in the system model, when the chip is attacked, obtaining the minimum cut set of the model by using an incidence matrix, and calculating the probability that each basic event is attacked,

wherein through the above steps, the Petri net model is used to analyze the chip security, which provides a basis for the prevention and targeted detection of hardware Trojan; based on the chip structure, the behavior and the description of the chip are decomposed into three levels, which are converted into Petri net model; the chip security is analyzed, which quantitatively measures the chip security according to the basis and form a security measurement standard; and the analysis method is simple and practical, easy to implement, and worth popularizing and applying.

Specifically, the security analysis results of the chip comprise the credibility of the system and the importance of the bottom unit.

The credibility of the system is the probability that the system can run safely under the specified time.

The importance of the bottom unit is used to analyze the weak link of the system on hardware Trojan attacks. The higher the importance of the bottom unit, the higher the probability that it is attacked by hardware Trojan, and the more necessary it is to design hardware Trojan defense measures in the unit, or carry out hardware Trojan detection for the unit module.

At the same time, the token type in the unit indicates the type that may be attacked by the hardware Trojan, and the corresponding hardware Trojan detection method should be selected for targeted detection. For example, the side channel signal analysis and detection method should be used for the hardware Trojan of a leaking information type, and the logic test method can be used for changing the hardware Trojan of a function type.

“According to the composition of the top unit, decomposing the system into three levels” in Step 1 specifically comprises:

traversing all modules in V file and finding the module that is not called by other modules as the top unit;

traversing all modules in V file again, and find the module that has not called other modules and is only called as the bottom unit;

placing other modules into the system as intermediate units according to the calling relationship;

when not only other modules are called in the modules in the intermediate unit and the top unit, but also assign statements or always structure blocks exit, these assign statements or always structure blocks are also likely to be attacked by hardware Trojan and also serve as the bottom units;

according to the calling relationship between each unit, analyzing the composition of the system, and establishing the hierarchical relationship.

“Establishing a Petri net model of a bottom unit” in Step 2 specifically comprises:

establishing the PN model of a single bottom unit only considering the two states of the bottom unit, that is, “working” or “failing” after being attacked by a hardware Trojan, wherein it is assumed that the failure transition T is triggered according to the triggering probability λ of the hardware Trojan, the state change of the bottom unit from “working” to “failing” is displayed by the change of token in the place; because the attack on the bottom unit can approximate Poisson process with intensity λ, and once the attack is successfully launched, the bottom unit will fail, so that the failure time of the bottom unit obeys the exponential distribution; λ is equal to the probability that a hardware Trojan is triggered in a hardware Trojan attack, and the formula for calculating the transition rate is F(t)=1−e^{-λt}, where F(t) is the function of the transition rate with respect to time t.

“Converting the intermediate unit model into an equivalent single network model” in Step 3 specifically comprises:

according to the structure of the chip, converting the intermediate unit model into an equivalent single network model, wherein the basic structure of the behavior-level description language of the chip is connected in series and parallel, and in addition, other structures are converted into the combination of series-parallel structures;

wherein in a series system, if the failure transition of any bottom unit in the series system is triggered, the whole intermediate unit will fail, and the expression of the equivalent transition rate, i.e. failure rate, of the intermediate unit formed by connecting n bottom units in series is:

$${F}_{z} ( t ) = 1 - {\prod }_{i = 1}^{n} ( 1 - {F}_{i} ( t ) )$$

where F₂(t) represents the equivalent failure rate of the intermediate units connected in series, and F₁(t) represents the failure rate of the i-th bottom unit which constitutes the intermediate units connected in series;

wherein in a parallel system, the intermediate unit will fail when all the bottom units forming the intermediate unit connected in parallel are in failure state, according to the exponential failure distribution of components, the failure rate of an equivalent single network model can be obtained, and the expression of the equivalent transition rate (failure rate) of intermediate units formed by connecting n components with exponential failure distribution in parallel is:

$${F}_{p} ( t ) = {\prod }_{i = 1}^{n} F \text{?} ( t )$$

$$\text{?} \text{indicates text missing or illegible when filed}$$

where Fₚ(t) represents the equivalent failure rate of the intermediate units connected in series.

“Analyzing the composition and the dynamic characteristics of the top unit” in Step 4 specifically comprises:

in the behavior level description, calling a module by a plurality of different modules, that is, a plurality of intermediate units sharing a bottom unit, wherein when one bottom unit is attacked, a plurality of intermediate units may fail, which is referred to as common cause failure, and the failure transition of the common cause failure mode is triggered according to the failure rate assigned thereto;

in the actual hardware system, determining the transition rate of the bottom unit from the trigger rate of hardware Trojan, wherein the trigger structure, the trigger rate and the transition rate of hardware Trojan in the same unit are the same, so that in the hardware Trojan diagnosis, T_{i-f(ccf)}^{j}=T_{i-f(m)}^{j}; where T_{i-f(m)}^{j} corresponds to the fact that the i-th component changes from normal state to failure state due to its own reasons, and T_{i-f(ccf)}^{j} corresponds to the fact that the i-th component changes from normal state to failure state due to a common cause.

“Evaluating the credibility of the system and the intermediate unit by calculating the transition rate of each place in the system model” in Step 5 specifically comprises:

obtaining the credibility of the corresponding hardware unit by analyzing the credibility of each place in the model, wherein the Petri net model established in step 1 to step 4 is a failure model that describes the system after being attacked by a hardware Trojan based on the hardware system structure, therefore, the transition rate specified by the transition in the model describes the failure rate of the transition reaching the place, so that the failure rate of each hardware unit in the system is equal to the transition rate of the corresponding place, the credibility and the failure rate of each place are shown in the following formula:

Rᵢ(t)=1−Fᵢ(t)

where i=1, 2, 3, . . . , n represents the i-th component in the intermediate unit;

wherein the failure rate of a single bottom unit is calculated from the corresponding transition rate, the failure rate of the intermediate unit is calculated from the transition rate of its corresponding intermediate unit equivalent single network model, and the credibility of a single network equivalent model of a parallel system and a series system is calculated as follows:

$$R \text{?} ( t ) = 1 - F \text{?} ( t ) = {\prod }_{i = 1}^{n} ( 1 - F \text{?} ( t ) ) = {\prod }_{i = 1}^{n} R \text{?} ( t )$$

$${R}_{p} ( t ) = 1 - {F}_{p} ( t ) = 1 - {\prod }_{i = 1}^{n} F \text{?} ( t ) = 1 - {\prod }_{i = 1}^{n} ( 1 - R \text{?} ( t ) )$$

$$\text{?} \text{indicates text missing or illegible when filed}$$

where Rₛ(t) represents the equivalent failure rate of intermediate units connected in series, and Rₚ(t) represents the equivalent failure rate of intermediate units connected in parallel.

“Obtaining the minimum cut set of the model by using an incidence matrix” in Step 5 specifically comprises:

expressing the structure of Petri net by a matrix, wherein if the number of input tokens from place P to transition T is a non-negative integer W, which is denoted as I(P, T)=w, it is represented by a directed arc from P to T with W as a side note; if the number of output tokens from transition T to place P is a non-negative integer n, which is denoted as O(P, T)=n, it is represented by a directed arc from T to P with n as a side note; the difference between O and I, A=O−I, is referred to as an incidence matrix; the hardware system studied in the present disclosure will fail when being attacked, so w=n=1;

wherein in the incidence matrix, −1 represents a directed arc of the transition pointed by the place, that is, the place is the input place of the transition; 1 indicates a directed arc from the transition to the place, that is, the place is the output place of the transition; the specific step of solving the minimum cut set according to the incidence matrix is as follows:

finding the row in the incidence matrix with only elements 1 and 0 and no −1, that is, the row corresponding to the top place (only the input place but no output place), and starting from this row (the last row in the incidence matrix);

(2) starting from element 1 in the row corresponding to the top place, finding −1 by column, wherein the place corresponding to the row where −1 is located is an input place of the top place, if there are multiple elements −1 in the column, it means that there are multiple input places corresponding to the same transition, and the input places have an AND relationship;

(3) according to the −1 found in step (2), searching for 1 by row, wherein when there is 1 in this row, it means that the place is an intermediate place, continuing to searching for other elements 1 in the row corresponding to the top place circularly according to step (2) until every column where 1 is located has been searched, when there is no 1 in the row where −1 is located, it means that the place corresponding to the row is a bottom place, and if there are multiple elements 1 in the row, it means that the places corresponding to the elements 1 have an OR relationship, and all the bottom places are found;

(4) expanding all the bottom places and obtaining the minimum cut set according to Boolean algebra method.

The specific calculating method of “the probability that each basic event is attacked” in step 5 is as follows:

the units in the minimum cut set include one or more repositories, the units are in parallel relationship, the places in the same unit are in series relationship, and it is assumed that Qi(t) represents the probability that the i-th basic event occurs at time t, Cⱼ=[x₁, x₂, . . . , Xᵢ, . . . Xᵣ] represents the j-th minimum cut set, and xᵢ is the cut set element,

when each basic event is an independent event, the probability that the jth minimum cut set occurs is:

$$F ( {C}_{j} ) = P ( {⋂}_{i = 1}^{r} {X}_{i} ) = {\prod }_{i = 1}^{r} {Q}_{i} ( t )$$

according to the principle of more division and less compensation of probability, the failure probability of the top event is:

$$F ( TOP ) = P ( {{⋃}^{N}}_{j = 1} {C}_{j} ) \approx {\sum }_{j = 1}^{N} ( {C}_{j} )$$

where N is the number of minimum cut sets of the system;

therefore, the importance of the minimum cut set is:

$${I}_{{C}_{j}} = \frac{P ( {C}_{j} )}{F ( TOP )}$$

the importance of the basic event, that is, the probability that a basic event is attacked by hardware Trojan, is

$${I}_{X} \text{?} = \frac{1}{F ( TOP )} {\sum }_{X \text{?} \text{?} C \text{?}}^{ } [ P ( {C}_{j} ) P ( {X}_{i} ) / {\sum }_{z = 1}^{r} P ( X \text{?} ) ]$$

$$\text{?} \text{indicates text missing or illegible when filed}$$

where P(Xᵢ) is the probability of basic events; P(Xₛ) is the probability of basic events Xₛ in the minimum cut set Cⱼ, s=1, 2, . . . , r is the order of the minimum cut set Cⱼ.

### 3. Advantages and Effects

The present disclosure provides a chip security analysis method based on Petri net, which has the following advantages.

A basis is provided for the prevention and targeted detection of hardware Trojan.

(2) Based on the chip structure, the behavior and the description of the chip are decomposed into three levels, which are converted into a Petri net model to analyze the chip security, which quantitatively measures the chip security according to the basis and form a security measurement standard.

(3) The analysis method is simple and practical, easy to implement, and worth popularizing and applying.

### BRIEF DESCRIPTION OF THE DRAWINGS

FIG. 1 is a flow chart of a chip security analysis method based on Petri net.

FIG. 2 is a diagram of the calling relationship of units inside an AES chip.

FIG. 3 is a diagram of a Petri net model of an AES chip.

The serial numbers, symbols and codes in the figures are described as follows.

In the relational matrix result, “Δ”, “∘” and “⊚” indicate the type of hardware Trojan:

“Δ” stands for denial of service;

“∘” stands for changing functions;

“⊚” stands for leaking information.

### DETAILED DESCRIPTION

In the existing cases, the types of hardware Trojan attacks include denial of service, changing functions and leaking information. According to the above three types of hardware Trojan attacks, the chip security analysis is carried out. Combined with the actual case of the AES chip, the chip security analysis method based on Petri net described in the present disclosure is described in detail.

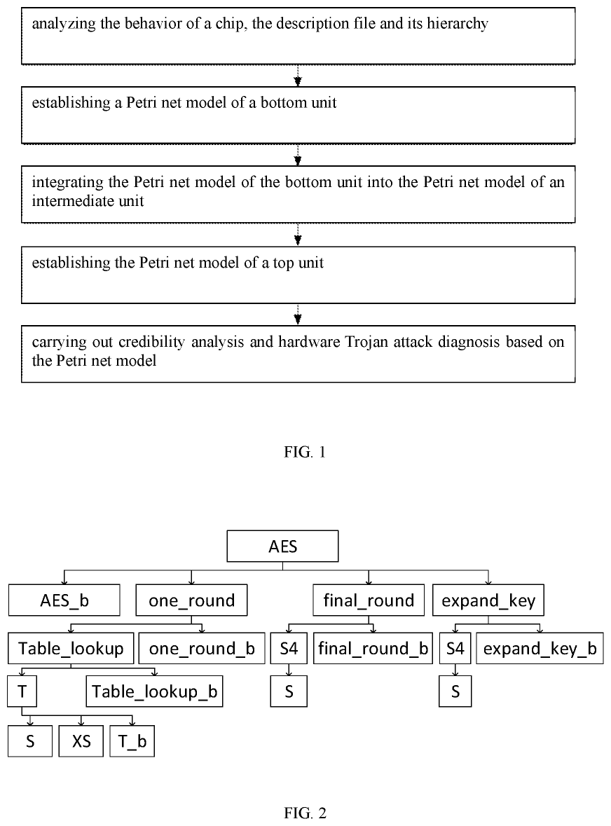

The flow chart of the chip security analysis method based on Petri net according to the present disclosure is shown in FIG. 1, and the specific implementation steps are as follows.

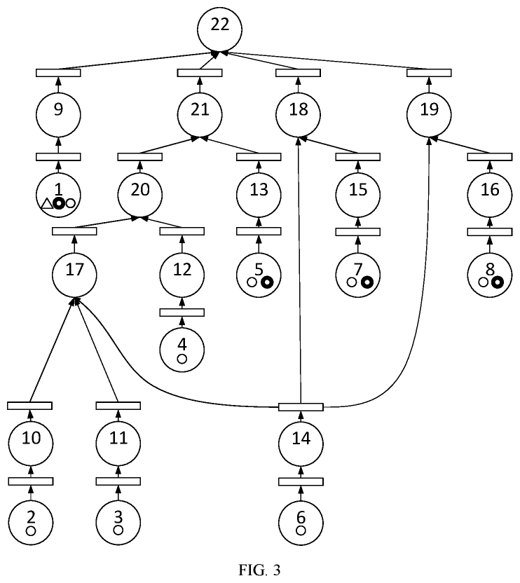

Step 1: The behavior of a chip, the description file and its hierarchy are analyzed. According to the behavior of the chip and the composition of the description file, the chip is decomposed into three levels. The first level is a top unit; the second level comprises several intermediate units after the top unit is decomposed; and the third level comprises several bottom units after each intermediate unit is decomposed. The AES system includes three V files, namely aes_128, table and round. The relationship between calling and called is shown in FIG. 2. AES is the top unit, and one_round, final_round, expand_key, Table_lookup, and T are the intermediate units. Aes_b, one_round_b, final_round_b, expand_key_b, Table_lookup_b, T_b, XS and S are the bottom units.

Step 2: A Petri net model of a bottom unit is established. There are two places and one transition in this model. According to the fact that the bottom unit attacked by hardware Trojan obeys the exponential distribution, the transition rate of the model is obtained. Tokens with different shapes are added to the place to mark the type of hardware Trojan of the bottom unit that may be attacked. “Δ” stands for denial of service, “∘” stands for changing functions, and “⊚” stands for leaking information.

Step 3: The Petri net model of the bottom unit is integrated into the Petri net model of an intermediate unit. The intermediate unit model is then converted into an equivalent single network model. The equivalent conversion rate of each single network model is obtained according to the composition of the intermediate unit and the failure distribution parameters of the bottom unit.

Step 4: The Petri net model of a top unit is established. The composition structure and the dynamic characteristics of the top unit are analyzed, such as common cause failure. The top unit model is obtained by integrating the single network model of the intermediate unit obtained in step 3, as shown in FIG. 3.

Step 5: Credibility analysis and hardware Trojan attack diagnosis are carried out based on the Petri net model. The credibility of the top unit and the intermediate unit are evaluated by calculating the transition rate of each place in the system model. When the system is attacked, the minimum cut set of the model is obtained by using an incidence matrix, and the probability that each basic event is attacked is calculated.

Because the hardware Trojan attack obeys exponential distribution, the failure rate of the bottom unit is equal to the trigger probability of the hardware Trojan. The trigger structure and the payload of hardware Trojan are relatively independent in function and structure. Therefore, the trigger probability of the hardware Trojan is not affected by the type of the hardware Trojan attacks. In the present disclosure, the external trigger in trust-hub is selected as the trigger structure of the hardware Trojan. Therefore,

$$\text{?} ct = \text{?} \text{?} = \text{?} ds = \frac{\text{?}}{\text{?} \text{?}} . \\ \text{?} \text{indicates text missing or illegible when filed}$$

Because each attack type is in series relationship, that is, the occurrence of any one type can complete the attack, the credibility of the bottom unit is

R₉(t)=e^{-(λ}^{_{ef}}^{+λ}^{_{II}}^{+λ}^{_{ds}}^{)t}

R₁₃(t)=R₁₅(t)=R₁₆(t)=e^{-(λ}^{_{ef}}^{+λ}^{_{II}}^{)t}

R₁₀(t)=R₁₂(t)=R₁₄(t)=e^{-λ}^{_{ef}}^{t}

where t represents the number of times the system runs. Since the subsystem structures in this system are all in series, the creditability of each intermediate unit and each top unit can be calculated as follows

R₁₇(t)=R₁₆(t)·R₁₁(t)·R₁₄(t)

R₂₀(t)=R₁₇(t)·R₁₂(t)

R₂₁(t)=R₂₀(t)·R₁₃(t)

R₁₈(t)=R₁₄(t)·R₁₅(t)

R₁₉(t)=R₁₄(t)·R₁₆(t)

R₂₂(t)=R₁₈(t)·R₁₉(t)·R₂₁(t)·R₉(t)

Hardware systems on integrated circuits usually need to be used together with corresponding memories. At present, the flash memory can be erased 100,000 to one million times. The hardware system with 10 million, 1 million and 100,000 operations can guide the design of defense and monitoring of hardware Trojan. The calculation results are shown in the following table.

| Units | t = 10,000,000 | t = 1,000,000 | t = 100,000 |
|---|---|---|---|
| R17 | 0.9953 | 0.9995 | 0.9999 |
| R18 | 0.9930 | 0.9993 | 0.9999 |
| R19 | 0.9930 | 0.9993 | 0.9999 |
| R20 | 0.9930 | 0.9993 | 0.9999 |
| R21 | 0.9884 | 0.9988 | 0.9998 |
| R22 | 0.9679 | 0.9967 | 0.9996 |

From the calculation results, it can be concluded that the credibility that the whole system runs is very high when it is operated for 100,000 times. The whole system can run normally with a high probability, and the credibility is above 99.96%. The results are in line with the actual situation, because the hardware Trojan needs to be hidden in the integrated circuit implanted by the designer to prevent it from being exposed in the early functional test. With the increase of operation times, the credibility of the system decreases, because with the increase of operation times, the probability that the hardware Trojan may be triggered increases, which leads to the decrease of the credibility of the system from 99.96% to 96.79%. At this time, the system already has a certain risk of being attacked by hardware Trojan. With the increase of operation times, the credibility reduction of each subsystem is lower than that of the whole system, because the whole system is formed by connecting subsystems in series.

After that, the importance analysis is carried out. Firstly, the minimum cut sets in the network model are analyzed. According to the incidence matrix, it can be concluded that the minimum cut sets of the system are {P1}, {P2}, {P3}, {P4}, {P5}, {P6}, {P7}, {P8}. Since each minimum cut set contains only one place, the calculation formula of the importance of the place is as follows.

$${I}_{{C}_{j}} = \frac{P ( {C}_{j} )}{F ( TOP )} = \frac{P ( {t}_{j} )}{F ( TOP )}$$

where P(tⱼ) represents the occurrence probability of transition, which is equivalent to the probability that the place is attacked. The importance of each unit in the minimum cut sets when the system operates 10 million times, 1 million times and 100,000 times is calculated, respectively, as shown in the following table.

| T = | 10000000 | 1000000 | 100000 |
|---|---|---|---|
| P1 | 0.217038267 | 0.214560207 | 0.214313156 |
| P2 | 0.072514598 | 0.071536722 | 0.071439382 |
| P3 | 0.072514598 | 0.071536722 | 0.071439382 |
| P4 | 0.072514598 | 0.071536722 | 0.071439382 |
| P5 | 0.144860557 | 0.143056789 | 0.142877101 |
| P6 | 0.072514598 | 0.071536722 | 0.071439382 |
| P7 | 0.144860557 | 0.143056789 | 0.142877101 |
| P8 | 0.144860557 | 0.143056789 | 0.142877101 |

It can be seen from the results that P1 has the highest importance. That is, when the hardware system fails, it is most likely to be caused by the attack of AES_b unit. Secondly, P5, p7 and P8 correspond to one_round_b, final_round_b and expand_key_b units, respectively. The lowest probability is P2, P3, P4 and P6, which correspond to S, XS, t_b and table_lookup_b units, respectively. The possibility that the bottom units of many types of hardware Trojan may be attacked by hardware Trojan is high, while the possibility that the bottom units may be attacked by a single type of attacks is low. Therefore, in the failure diagnosis, the bottom units should be checked one by one according to the importance, and the hardware Trojan attack can be diagnosed systematically and completely.

What is claimed is:

1. A chip security analysis method based on Petri net, comprising the steps of:
Step 1: analyzing the behavior of a chip, the description file and its hierarchy, and according to the behavior of the chip and the composition of the description file, decomposing the chip into three levels, wherein the first level is a top unit; the second level comprises several intermediate units after the top unit is decomposed; and the third level comprises several bottom units after each intermediate unit is decomposed;
Step 2: establishing a Petri net model of a bottom unit, wherein there are two places and one transition in this model, according to the fact that the bottom unit attacked by hardware Trojan obeys the exponential distribution, the transition rate of the model is obtained, and tokens with different shapes are added to the place to mark the type of hardware Trojan of the bottom unit that may be attacked;
Step 3: integrating the Petri net model of the bottom unit into the Petri net model of an intermediate unit, then converting the intermediate unit model into an equivalent single network model, and obtaining the equivalent conversion rate of each single network model according to the composition of the intermediate unit and the failure distribution parameters of the bottom unit;
Step 4: establishing the Petri net model of a top unit, analyzing the composition and the dynamic characteristics of the top unit, such as common cause failure, and obtaining the top unit model by integrating the single network model of the intermediate unit obtained in step 3;
Step 5: carrying out credibility analysis and hardware Trojan attack diagnosis based on the Petri net model, evaluating the credibility of the top unit and the intermediate unit by calculating the transition rate of each place in the system model, when the system is attacked, obtaining the minimum cut set of the model by using an incidence matrix, and calculating the probability that each basic event is attacked,
wherein through the above steps, the Petri net model is used to analyze the chip security, which provides a basis for the prevention and targeted detection of hardware Trojan; based on the chip structure, the behavior and the description of the chip are decomposed into three levels, which are converted into Petri net model; the chip security is analyzed, which quantitatively measures the chip security according to the basis and form a security measurement standard.

2. The chip security analysis method based on Petri net according to claim 1, wherein:
“according to the composition of the top unit, decomposing the system into three levels” in Step 1 specifically comprises:
traversing all modules in V file and finding the module that is not called by other modules as the top unit;
traversing all modules in V file again, and finding the module that has not called other modules and is only called as the bottom unit;
placing other modules into the system as intermediate units according to the calling relationship;
when not only other modules are called in the modules in the intermediate unit and the top unit, but also assign statements or always structure blocks exit, these assign statements or always structure blocks are also likely to be attacked by hardware Trojan and also serve as the bottom units;
according to the calling relationship between each unit, analyzing the composition of the system, and establishing the hierarchical relationship.

3. The chip security analysis method based on Petri net according to claim 1, wherein:
“establishing a Petri net model of a bottom unit” in Step 2 specifically comprises:
establishing the PN model of a single bottom unit only considering the two states of the bottom unit, that is, “working” or “failing” after being attacked by a hardware Trojan, wherein it is assumed that the failure transition T is triggered according to the triggering probability λ of the hardware Trojan, the state change of the bottom unit from “working” to “failing” is displayed by the change of token in the place; because the attack on the bottom unit can approximate Poisson process with intensity λ, and once the attack is successfully launched, the bottom unit will fail, so that the failure time of the bottom unit obeys the exponential distribution; λ is equal to the probability that a hardware Trojan is triggered in a hardware Trojan attack, and the formula for calculating the transition rate is F(t)=1−e^{-λt}, where F(t) is the function of the transition rate with respect to time t.

4. The chip security analysis method based on Petri net according to claim 1, wherein:
“converting the intermediate unit model into an equivalent single network model” in Step 3 specifically comprises:
according to the structure of the chip, converting the intermediate unit model into an equivalent single network model, wherein the basic structure of the behavior-level description language of the chip is connected in series and parallel, and in addition, other structures are converted into the combination of series-parallel structures;
wherein in a series system, if the failure transition of any bottom unit in the series system is triggered, the whole intermediate unit will fail, and the expression of the equivalent transition rate, i.e. failure rate, of the intermediate unit formed by connecting n bottom units in series is:
$${F}_{s} ( t ) = 1 - {\prod }_{i = 1}^{n} ( 1 - {F}_{i} ( t ) )$$
where Fₛ(t) represents the equivalent failure rate of the intermediate units connected in series, and Fᵢ(t) represents the failure rate of the i-th bottom unit which constitutes the intermediate units connected in series;
wherein in a parallel system, the intermediate unit will fail when all the bottom units forming the intermediate unit connected in parallel are in failure state, according to the exponential failure distribution of components, the failure rate of an equivalent single network model can be obtained, and the expression of the equivalent transition rate (failure rate) of intermediate units formed by connecting n components with exponential failure distribution in parallel is:
$${F}_{p} ( t ) = {\prod }_{i = 1}^{n} {F}_{i} ( t )$$
where Fₚ(t) represents the equivalent failure rate of the intermediate units connected in series.

5. The chip security analysis method based on Petri net according to claim 1, wherein:
“analyzing the composition and the dynamic characteristics of the top unit” in Step 4 specifically comprises:
in the behavior level description, calling a module from a plurality of different modules, that is, a plurality of intermediate units sharing a bottom unit, wherein when one bottom unit is attacked, a plurality of intermediate units may fail, which is referred to as common cause failure, and the failure transition of the common cause failure mode is triggered according to the failure rate assigned thereto;
in the actual hardware system, determining the transition rate of the bottom unit from the trigger rate of hardware Trojan, wherein the trigger structure, the trigger rate and the transition rate of hardware Trojan in the same unit are the same, so that in the hardware Trojan diagnosis, T_{i-f(ccf)}^{j}=T_{i-f(m)}^{j};
where T_{i-f(m)}^{j} corresponds to the fact that the i-th component changes from normal state to failure state due to its own reasons, and T_{i-f(ccf)}^{j} corresponds to the fact that the i-th component changes from normal state to failure state due to a common cause.

6. The chip security analysis method based on Petri net according to claim 1, wherein:
“evaluating the credibility of the system and the intermediate unit by calculating the transition rate of each place in the system model” in Step 5 specifically comprises:
obtaining the credibility of the corresponding hardware unit by analyzing the credibility of each place in the model, wherein the Petri net model established in step 1 to step 4 is a failure model that describes the system after being attacked by a hardware Trojan based on the hardware system structure, therefore, the transition rate specified by the transition in the model describes the failure rate of the transition reaching the place, so that the failure rate of each hardware unit in the system is equal to the transition rate of the corresponding place, and the credibility and the failure rate of each place are shown in the following formula:
Rᵢ(t)=1−Fᵢ(t)
where i is an integer ranging from 1 to n and represents the i-th component in the intermediate unit;
wherein the failure rate of a single bottom unit is calculated from the corresponding transition rate, the failure rate of the intermediate unit is calculated from the transition rate of its corresponding intermediate unit equivalent single network model, and the credibility of a single network equivalent model of a parallel system and a series system is calculated as follows:
$${R}_{z} ( t ) = 1 - {F}_{s} ( t ) = {\prod }_{i = 1}^{n} ( 1 - F \text{?} ( t ) ) = {\prod }_{i = 1}^{n} R \text{?} ( t )$$
$${R}_{p} ( t ) = 1 - {F}_{p} ( t ) = 1 - {\prod }_{i = 1}^{n} {F}_{i} ( t ) = 1 - {\prod }_{i = 1}^{n} ( 1 - {R}_{i} ( t ) )$$
$$\text{?} \text{indicates text missing or illegible when filed}$$
where Rₛ(t) represents the equivalent failure rate of intermediate units connected in series, and Rₚ(t) represents the equivalent failure rate of intermediate units connected in parallel.

7. The chip security analysis method based on Petri net according to claim 1, wherein:
“obtaining the minimum cut set of the model by using an incidence matrix” in Step 5 specifically comprises:
expressing the structure of Petri net by a matrix, wherein if the number of input tokens from place P to transition T is a non-negative integer W, which is denoted as I(P, T)=w, it is represented by a directed arc from P to T with Was a side note; if the number of output tokens from transition T to place P is a non-negative integer n, which is denoted as O(P, T)=n, it is represented by a directed arc from T to P with n as a side note; the difference between O and I, A=O−I, is referred to as an incidence matrix; the hardware system studied in the present disclosure will fail when being attacked, so w=n=1;
wherein in the incidence matrix, −1 represents a directed arc of the transition pointed by the place, that is, the place is the input place of the transition; 1 indicates a directed arc from the transition to the place, that is, the place is the output place of the transition; the specific step of solving the minimum cut set according to the incidence matrix is as follows:
(1) finding the row in the incidence matrix with only elements 1 and 0 and no −1, that is, the row corresponding to the top place (only the input place but no output place), and starting from this row (the last row in the incidence matrix);
(2) starting from element 1 in the row corresponding to the top place, finding −1 by column, wherein the place corresponding to the row where −1 is located is an input place of the top place, if there are multiple elements −1 in the column, it means that there are multiple input places corresponding to the same transition, and the input places have an AND relationship;
(3) according to the −1 found in step (2), searching for 1 by row, wherein when there is 1 in this row, it means that the place is an intermediate place, continuing to searching for other elements 1 in the row corresponding to the top place circularly according to step (2) until every column where 1 is located has been searched, when there is no 1 in the row where −1 is located, it means that the place corresponding to the row is a bottom place, and if there are multiple elements 1 in the row, it means that the places corresponding to the elements 1 have an OR relationship, and all the bottom places are found;
(4) expanding all the bottom places and obtaining the minimum cut set according to Boolean algebra method.

8. The chip security analysis method based on Petri net according to claim 1, wherein:
the specific calculating method of “the probability that each basic event is attacked” in step 5 is as follows:
the units in the minimum cut set include one or more repositories, the units are in parallel relationship, and the places in the same unit are in series relationship, and it is assumed that Qᵢ(t) represents the probability that the i-th basic event occurs at time t, Cⱼ=[X₁, X₂, . . . , Xᵢ, . . . Xᵣ] represents the jth minimum cut set, and xᵢ is the cut set element, when each basic event is an independent event, the probability that the jth minimum cut set occurs is:
$$F ( {C}_{j} ) = P ( {{⋂}^{r}}_{i = 1} ) {X}_{i} = {\prod }_{i = 1}^{r} {Q}_{i} ( t )$$
according to the principle of more division and less compensation of probability, the failure probability of the top event is:
$$F ( TOP ) = P ( {{⋃}^{N}}_{j = 1} {C}_{j} ) \approx {\sum }_{j = 1}^{N} P ( {C}_{j} )$$
where N is the number of minimum cut sets of the system;
therefore, the importance of the minimum cut set is:
$${I}_{{C}_{i}} = \frac{P ( {C}_{j} )}{F ( TOP )}$$
the importance of the basic event, that is, the probability that a basic event is attacked by hardware Trojan, is
$${I}_{{X}_{i}} = \frac{1}{F ( TOP )} {\sum }_{{X}_{i} \text{?} {C}_{j}}^{ } [ P ( {C}_{j} ) P ( {X}_{i} ) / {\sum }_{\text{?}}^{r} P ( X \text{?} ) ]$$
$$\text{?} \text{indicates text missing or illegible when filed}$$
where P(Xᵢ) is the probability of basic events; P(Xₛ) is the probability of basic events Xₛ in the minimum cut set Cⱼ, s is an integer ranging from 1 to r and is the order of the minimum cut set Cⱼ.
